(19) United States
(12) Patent Application Publication
(10) Pub. No.: US 2026/0351223 A1
(43) Pub. Date: Nov. 5, 2026

(54) DRUM PEDAL MECHANISM

(71) Applicant: K.H.S. MUSICAL INSTRUMENT CO., LTD., New Taipei City (TW)

(72) Inventor: CHIH-CHIEH CHIAO, New Taipei City (TW)

(73) Assignee: K.H.S. MUSICAL INSTRUMENT CO., LTD., New Taipei City (TW)

(21) Appl. No.: 19/195,310

(22) Filed: Apr. 30, 2025

(51) Int. Cl. G10D 13/11

(52) U.S. Cl. CPC G10D 13/11

(57) ABSTRACT

A drum pedal mechanism includes a footplate assembly having a rotatable rocker shaft; a rocker arm assembly; a footboard connected between the rocker arm assembly and the footplate assembly. The rocker arm assembly includes a drive arm connected to between a cam and a connection joint, the cam is connected to the rocker shaft, and the connection joint is connected to the footboard. A first elastic element is connected at an end to the rocker shaft and at another end to the footplate assembly. A second elastic element is connected at an end to the drive arm and at another end to one of the cam and the connection joint. When the footboard is pedaled downward, the rocker shaft is brought to rotate, the first and the second elastic element are simultaneously pulled to deform, and the footboard can be driven by two elastic restoring forces to an initial position.

### FIELD OF THE INVENTION

The present invention relates to a drum pedal mechanism, and more particularly, to a drum pedal mechanism that allows a footboard thereof to more quickly return to its initial state after being pedaled by a player.

### BACKGROUND OF THE INVENTION

A standard drum set used in drum set performance usually consists of a snare drum, a bass drum, one or more tom-toms, and various kinds of cymbals. Among others, the bass drum often plays a core part of the drum set. The bass drum is typically set on the floor and played with a foot pedal. The foot pedal is usually designed to have one end fixedly connected to a footplate and another end connected to a drum beater. When a player pedals down a footboard of the foot pedal, the footboard drives the drum beater via a cam, so that the drum beater is swung to strike a front head of the bass drum and produce sounds. With the drum foot pedal mechanism, the player's hands can be used exclusively to play other parts in the drum set.

In the high-intensity drum set performance, the player often needs to strike the bass drum repeatedly to show specific rhythms. However, each time the footboard drives the drum beater to strike the bass drum; the player has to wait until the drum beater is swung back to an initial position before he can start another pedaling of the footboard. The player tends to be largely restricted by the time needed for the footboard to return to its initial position, particularly when it is necessary to pedal the footboard quickly and continuously. The delayed returning of the footboard to its initial position inevitably has an adverse influence on the performing speed and the smoothness of rhythms.

### SUMMARY OF THE INVENTION

A primary object of the present invention is to provide a drum pedal mechanism, which includes not only a conventional coil spring, but also a second elastic element. With this arrangement, when the footboard being pedaled is released, the second elastic element can provide an additional elastic restoring force for the footboard to more quickly return to its initial position.

To achieve the above and other objects, the drum pedal mechanism according to a first preferred embodiment of the present invention includes a footplate assembly, a footboard, a rocker arm assembly, a first elastic element, and a second elastic element. The footplate assembly includes a footplate, two posts, and a rocker shaft. The footplate provided with a pivotal block at a rear end; the two posts are connected at two laterally opposite sides of the footplate and locates at a front end of the footplate; and the rocker shaft is rotatably connected to a top of the two posts. The footboard has a pivotal end and a pedaling end. The pivotal end is pivotally connected to the pivotal block of the footplate assembly; and a space is formed between the pedaling end and the footplate, such that the footboard is slant relative to the footplate. The rocker arm assembly is connected to between the rocker shaft and the pedaling end, and the rocker arm assembly includes a drive arm, a cam, and a connection joint. The drive arm is turnably connected to between the cam and the connection joint; the cam is fixedly mounted to the rocker shaft, such that the rocker shaft is capable of being swung synchronously with the cam; and the connection joint is fixedly mounted to the pedaling end, such that the connection joint is capable of being moved synchronously with the footboard. The first elastic element has an end connected to the rocker shaft and another end connected to one of the two posts. The second elastic element has an end connected to the drive arm and another end connected to one of the cam and the connection joint.

When the footboard is pedaled downward, the first elastic element is deformed by the rocker shaft to produce a first elastic restoring force; meanwhile, the second elastic element is deformed by the drive arm to produce a second elastic restoring force; and then when the footboard is released without pedaling, the footboard is quickly moved upward by the first elastic restoring force and the second elastic restoring force to return to an initial position.

In the first preferred embodiment, the footboard is provided with a rearward extended notch at the pedaling end, a part of the connection joint is accommodated in the notch without moving leftward and rightward relative to the pedaling end. And, the connection joint includes a connection body, which is extended rearward to a lower side of the footboard and is locked to the footboard using a screw.

Further, the connection joint includes two mounting sections extended forward and a connection space formed between the mounting sections. Each of the mounting sections is provided with a through bore communicable with the connection space. The drive arm includes a mounting opening, a connection pin, and two bearings. A middle portion of the connection pin is fixedly held in the mounting opening and two opposite end portions of the mounting opening are located outside the mounting opening, the bearings are connected to the end portions of the connection pin respectively. And, the bearings are rotatably fitted in the two through bores on the mounting sections, such that the drive arm is capable of being pivotally connected to the connection joint.

The second elastic element is configured as a coil spring; and the drive arm includes a locating block for fitting in a central area of the coil spring and a first locating hole located adjacent to the locating block. One of the cam and the connection joint is provided with a second locating hole, and the coil spring has two opposite ends separately fixedly fitted in the first locating hole and the second locating hole.

A first gap is formed between the coil spring and the locating block when the footboard is not pedaled. And, the coil spring is deformed by the drive arm to form a second gap when the footboard is pedaled downward, the second gap is smaller than the first gap.

In addition, the drive arm includes two pivot portions, an arm portion, and a rib portion. The arm portion is connected between the two pivot portions, and the rib portion is connected to between the pivot portions and the arm portion. The locating block fitted in the coil spring is provided on one of the pivot portions, a receiving space is formed between the locating block and the arm portion, and a recessed portion is provided on the arm portion for forming the first locating hole. And, the locating block has a top being flush with the arm portion, such that the coil spring is mounted in the receiving space and the recessed portion.

The drum pedal mechanism further includes a third elastic element, the third elastic element has an end connected to the drive arm and another end connected to another of the cam and the connection joint. And, the third elastic element is deformed by the rocker arm assembly to produce a third elastic restoring force when the footboard is pedaled downward.

The cam includes a fixing section, a fastening element, and a sliding section. The fixing section is fixedly mounted on the rocker shaft, such that the rocker shaft is capable of being swung synchronously with the cam. One end of the sliding section is pivotally connected to the drive arm, and the other end of the sliding section being slidably connected to the fixing section; so that a relative position between the sliding section and the fixing section is capable of being adjusted to change an overall length of the cam, and the sliding section is capable of being fixed by the fastening element without moving relative to the fixing section.

The present invention is featured by that the drum pedal mechanism includes not only the first elastic element, but also a second elastic element. The second elastic element is connected to between the drive arm and one of the cam and the connection joint. When the footboard is pedaled downward, the first elastic element produces the first elastic restoring force; meanwhile, the second elastic element is deformed by the drive arm to produce the second elastic restoring force. When the footboard is released without pedaling, the footboard is quickly moved upward by the first elastic restoring force and the second elastic restoring force to return to aninitial position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a drum pedal mechanism according to a first preferred embodiment of the present invention;

FIG. 2 is an exploded view of FIG. 1;

FIG. 3 is a sectional side view of the drum pedal mechanism according to the first preferred embodiment of the present invention, showing it in an initial position;

FIG. 4 is a fragmentary, enlarged rear view of the drum pedal mechanism according to the first preferred embodiment of the present invention;

FIG. 5 is an exploded perspective view of a rocker arm assembly and a second elastic element included in the drum pedal mechanism according to the first preferred embodiment of the present invention;

FIG. 6 is a side view of the drum pedal mechanism according to the first preferred embodiment of the present invention, showing it in a striking position;

FIG. 7 is a side view of the rocker arm assembly and the second elastic element included in the first preferred embodiment of the present invention, showing them in an initial position;

FIG. 8 is a side view of the rocker arm assembly and the second elastic element included in the first preferred embodiment of the present invention, showing them in a striking position;

FIG. 9 shows the rocker arm assembly, the second elastic element, and a third elastic element included in a second preferred embodiment of the present invention; and

FIG. 10 shows the rocker arm assembly, the second elastic element, and a fourth elastic element included in a third preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

Directional terms “front”, “rear”, “left”, “right”, “upper”, “lower”, etc. referred to in the present specification with respect to the accompanying drawings correspond to the directions in which a player faces when he uses a drum pedal mechanism 1 of the present invention.

The drum pedal mechanism 1 of the present invention is usually used with a bass drum. A player pedals the drum pedal mechanism 1 with a foot to swing a beater 11 that strikes the bass drum to perform different tempos or rhythms in music.

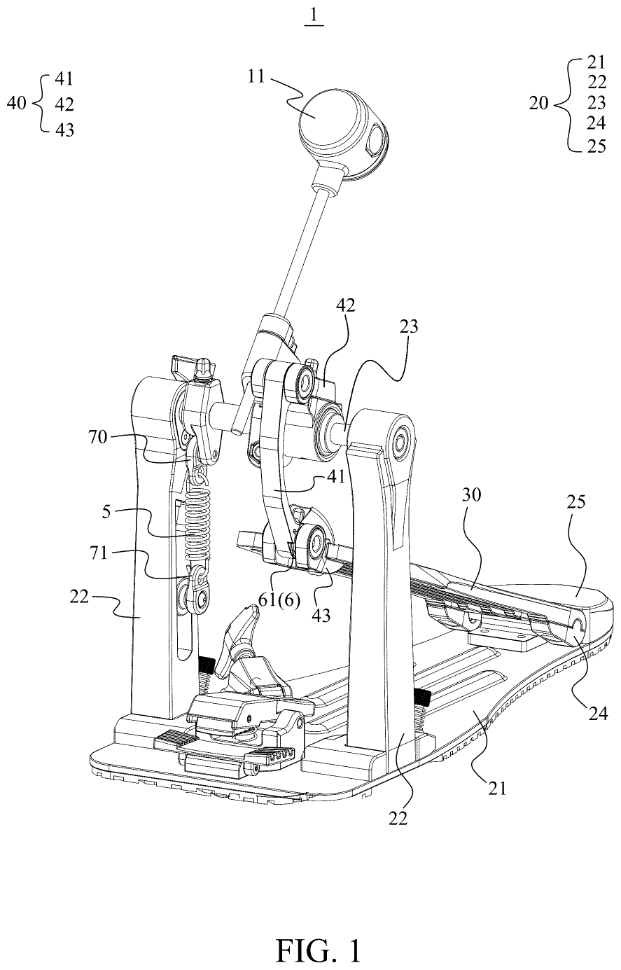

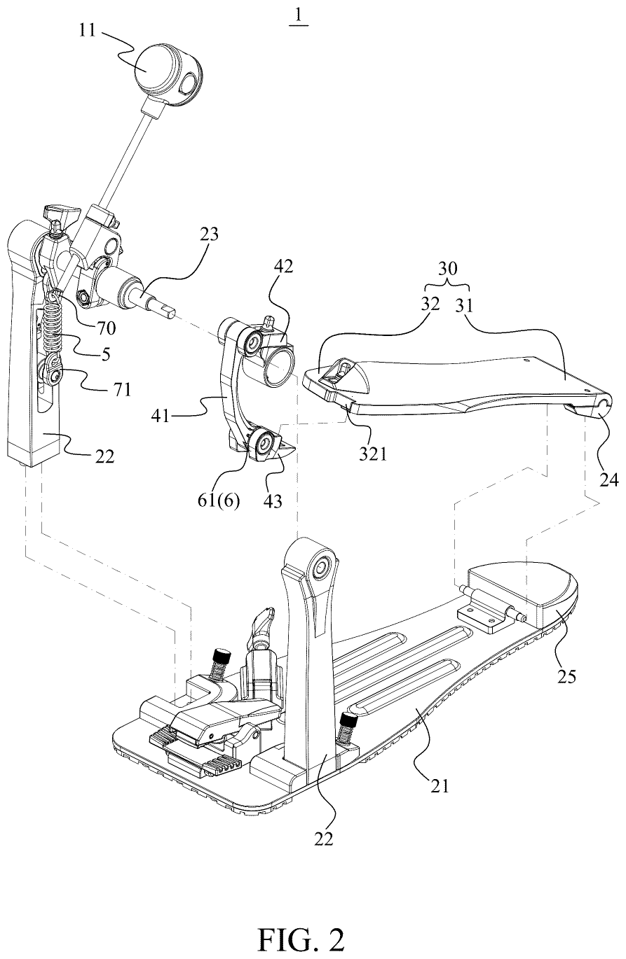

Please refer to FIGS. 1 to 3. The drum pedal mechanism 1 according to a first preferred embodiment of the present invention includes a footplate assembly 20, a footboard 30, a rocker arm assembly 40, a first elastic element 5, and a second elastic element 6. The footplate assembly 20 includes a footplate 21, two posts 22, and a rocker shaft 23. The footplate 21 is connected at a rear end with a pivotal block 24; the two posts 22 are located at a front end of the footplate 21 at two lateral sides thereof; and the rocker shaft 23 is provided on a top of the two posts 22 and is rotatably connected to between the two posts 22. The footboard 30 includes a rear end being a pivotal end 31 and a front end being a pedaling end 32. The pivotal end 31 is pivotally connected to the pivotal block 24 of the footplate assembly 20, and the pedaling end 32 is connected to the rocker arm assembly 40 to be suspended in an initial position S1. When the footboard 30 is located at the initial position S1, a space is formed between the pedaling end 32 and the footplate 21, so that the footboard 30 is slant relative to the footplate 21.

The footplate assembly 20 further includes a heel block 25 located behind the pivotal block 24. When the player pedals the footboard 30 with his heel placed on the heel block 25, he can pedal the footboard 30 more easily.

The rocker arm assembly 40 includes a drive arm 41, a cam 42, and a connection joint 43. The drive arm 41 is turnably connected at two ends to the cam 42 and the connection joint 43. The cam 42 is fixedly mounted on the rocker shaft 23, such that the cam 42 can bring the rocker shaft 23 to swing synchronously with the cam 42. The connection joint 43 is fixedly mounted to the pedaling end 32, such that the connection joint 43 can be brought by the footboard 30 to move synchronously with the footboard 30.

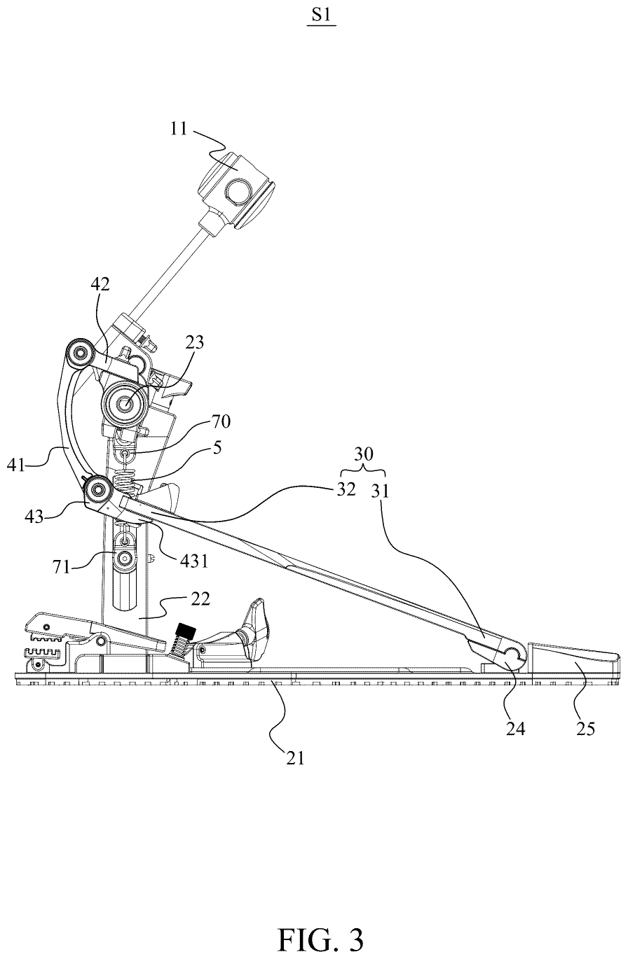

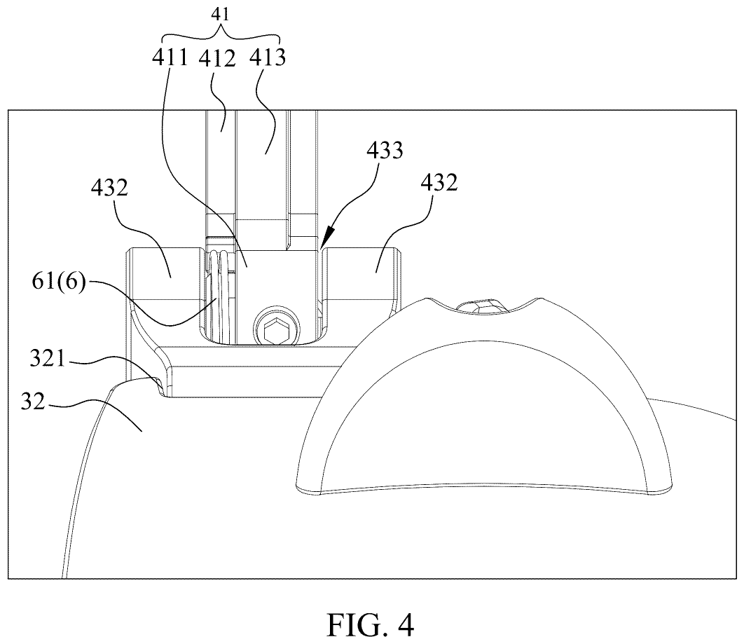

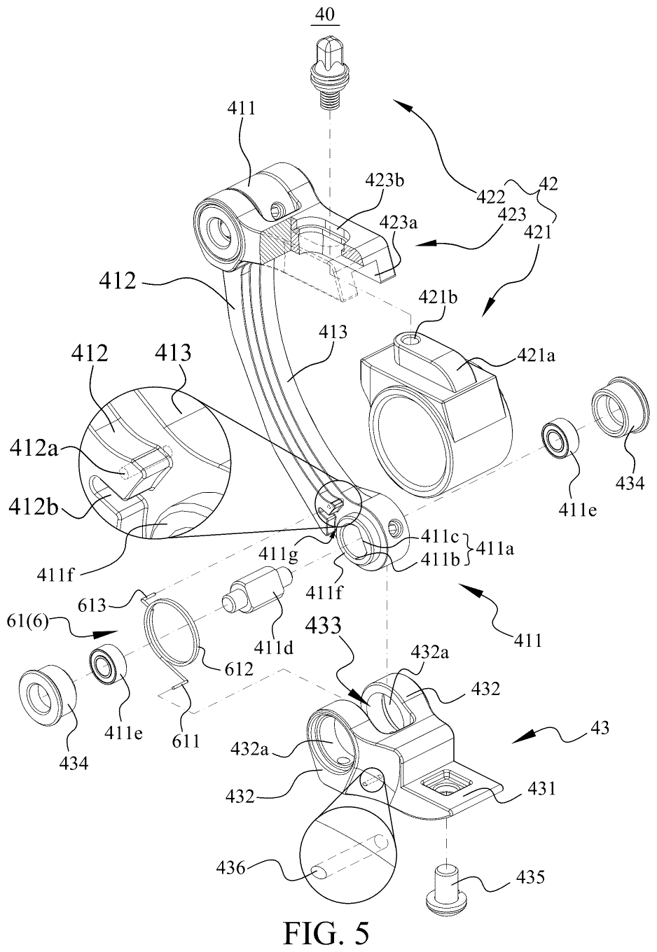

Please refer to FIGS. 3 to 5. The connection joint 43 includes a connection body 431, two mounting sections 432, a connection space 433 defined between the two mounting sections 432, and two outer caps 434. The connection body 431 is rearward extended to a lower side of the footboard 30 and is locked to a bottom of the footboard 30 by upward extending a screw 435 through the connection body 431 into the footboard 30, such that the connection body 435 can be brought to move synchronously with the footboard 30. The two mounting sections 432 and the connection space 433 are located in front of the connection body 431; and the two mounting sections 432 respectively have a through bore 432a communicable with the connection space 433.

The drive arm 41 includes two pivot portions 411, an arm portion 412, and a rib portion 413. The arm portion 412 is connected to between the two pivot portions 411. The rib portion 413 is connected to between the two pivot portions 411 and the arm portion 412. A lower one of the pivot portions 411 includes a mounting opening 411a, a connection pin 411d, and two bearings 411e. The mounting opening 411a includes a curved section 411b larger than half a circle and a straight section 411c, such that the mounting opening 411a has an irregular shape to fixedly hold the connection pin 411d in the mounting opening 411a while the connection pin 411d is partially protruded from two opposite ends of the mounting opening 411a, allowing the bearings 411e to be separately connected to two ends of the connection pin 411d. Meanwhile, the two bearings 411e are rotatably fitted in the two through bores 432a on the mounting sections 432 of the connection joint 43, such that the pivot section 411 is located in the connection space 433, allowing the drive arm 41 to be pivotally connected to the connection joint 43. In addition, the two outer caps 434 are separately located outside the two through bores 432a to cover a part of the bearings 411e, preventing the bearings 411e from falling out of the through bores 432a.

Please refer to FIGS. 1, 2, and 4. The pedaling end 32 is provided with a rearward extended notch 321 for accommodating a part of the connection joint 43, so that the connection joint 43 could not move laterally relative to the pedaling end 32. Further, the notch 321 is located close to a left or a right side of the pedaling end 32. In the case the footboard 30 is designed for pedaling by a player's right foot, the notch 321 would be provided closer to the left side of the pedaling end 32. On the other hand, when the footboard 30 is designed for pedaling by the player's left foot, the notch 321 would be provided closer to the right side of the pedaling end 32.

Please refer to FIGS. 1 to 5. The cam 42 includes a fixing section 421, a fastening element 422, and a sliding section 423. The fixing section 421 is fixedly mounted on the rocker shaft 23, such that the cam 42 can bring the rocker shaft 23 to swing synchronously with the cam 42. The fixing section 421 further includes a rail portion 421a and a screw locking hole 421b provided on the rail portion 421a. The sliding section 423 includes a slide rail portion 423a and a slide hole 423b. The sliding section 423 is pivotally connected at an end to the drive arm 41 and slidably connected at another end to the rail portion 421a via the slide rail portion 423a. The fastening element 422 is extended downward through the slide hole 423b to be fixed to the screw locking hole 421b. When the fastening element 422 is locked in place, the sliding section 423 is stopped from sliding relative to the fixing section 421, such that the player can change an overall length of the cam 42 by adjusting the fastening element 422.

The first elastic element 5 has an upper end connected to the rocker shaft 23 via a hanger plate 70, which can be brought by the rocker shaft 23 to swing synchronously. The first elastic element 5 has a lower end connected to one of the two posts 22 via an adjustment plate 71. An initial length of the first elastic element 5 can be changed by the player via the adjustment plate 71.

The second elastic element 6 has an end fixed to the drive arm 41 and another end fixed to one of the cam 42 and the connection joint 43. In the first preferred embodiment, the second elastic element 6 is illustrated as a coil spring 61. The lower pivot section 411 of the drive arm 41 includes a locating block 411f, which is fitted in a central area of the coil spring 61 and outward projected from the mounting openings 411a. The locating block 411f has a round outer configuration, around which the coil spring 61 is wound. The coil spring 61 has a first insert section 611, a winding section 612, and a second insert section 613. The drive arm 41 includes a first locating hole 412a provided at a position adjacent to the locating block 411f and the connection joint 43 is provided with a second locating hole 436. The first insert section 611 of the coil spring 61 is extended toward the drive arm 41 and fixedly inserted into the first locating hole 412a, while the second insert section 613 of the coil spring 61 is extended toward the connection joint 43 and fixedly inserted into the second locating hole 436.

A receiving space 411g is formed between the locating block 411f and the arm portion 412. The arm portion 412 further has a recessed portion 412b for forming the first locating hole 412a. The locating block 411f has a top being flush with the arm portion 412, such that the coil spring 61 can be mounted in the receiving space 411g and the recessed portion 412b.

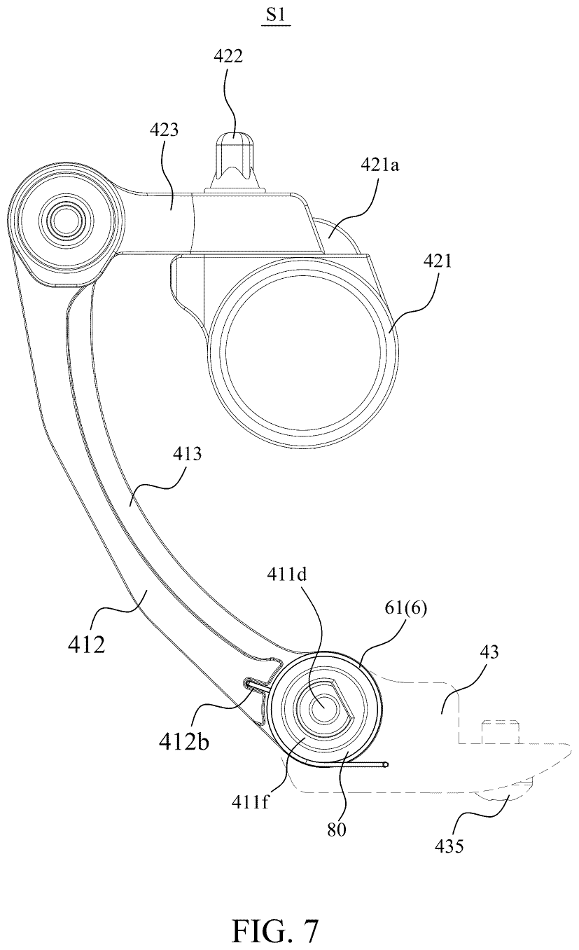

Please refer to FIGS. 3 and 7. When the footboard 30 is located at the initial position S1, a first gap 80 is existed between the winding section 612 of the coil spring 61 and an outer wall of the locating block 411f.

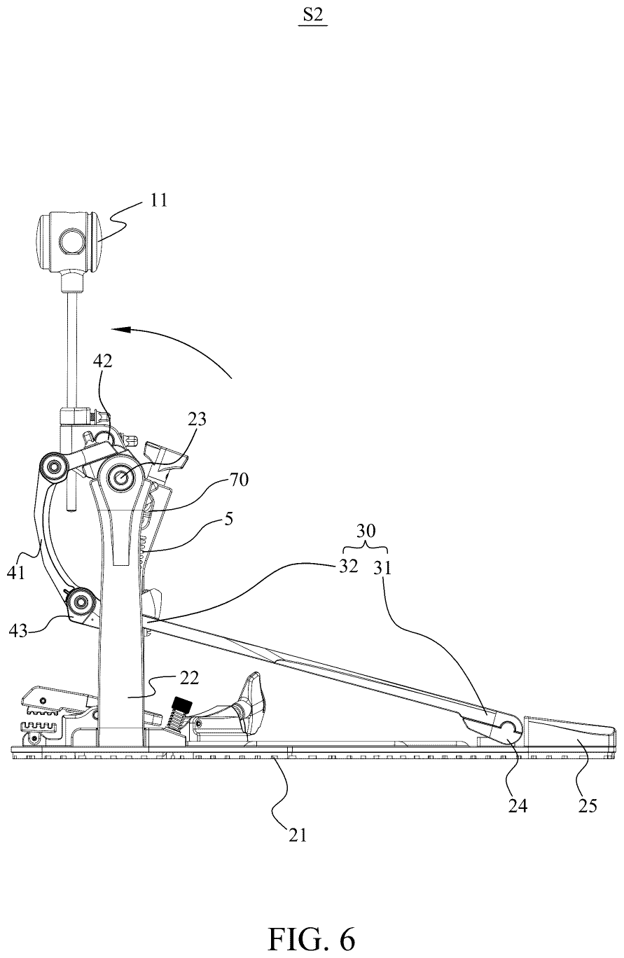

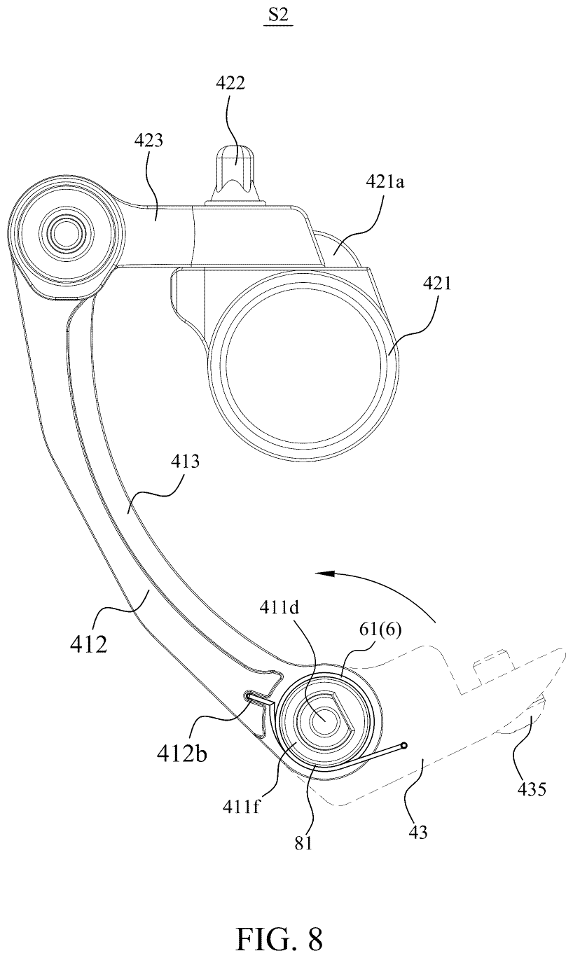

Please refer to FIGS. 6 and 8. When the footboard 30 is pedaled downward to a striking position S2, the rocker arm assembly 40 is pulled downward and the rocker shaft 23 is caused to rotate. When the rocker shaft 23 rotates, the adjustment plate 70 is rotated to pull the first elastic element 5 at its upper end, such that the first elastic element 5 is lengthened and deformed to produce a first elastic restoring force. Meanwhile, the drive arm 41 and the connection joint 43 are moved relative to each other to change a distance between them, causing the first locating hole 412a to separate from the second locating hole 436 and the coil spring 61 is pulled and deformed. Therefore, a second gap 81, which is smaller than the first gap 80, is formed between the winding section 612 and the outer wall of the locating block 411f to thereby produce a second elastic restoring force.

When the footboard 30 is not pedaled, it quickly returns from the striking position S2 to the initial position S1 under the first and the second elastic restoring force.

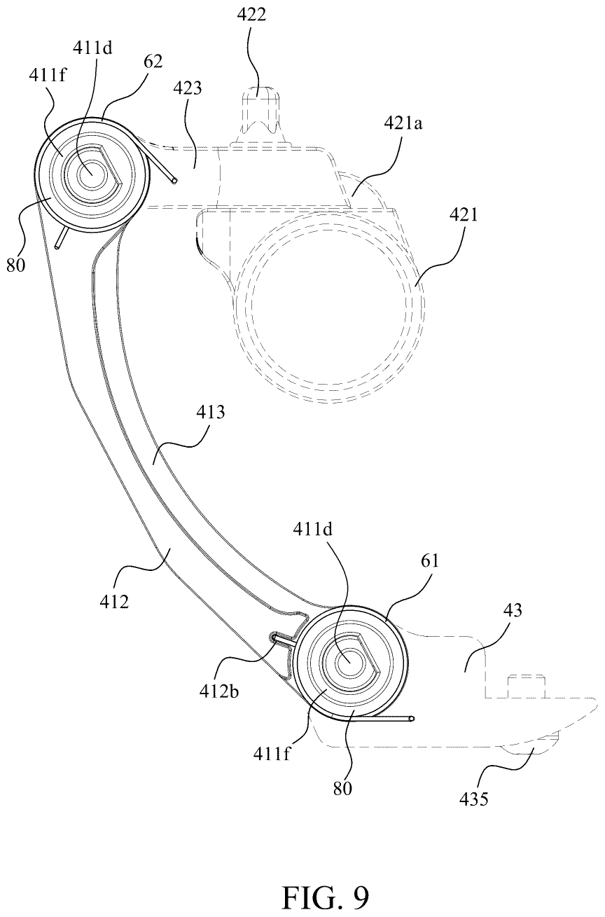

Please refer to FIGS. 1 to 3 and 9, in which a second preferred embodiment of the present invention is shown. The second preferred embodiment is different from the first one only in the number of the elastic elements. Since the second preferred embodiment is structurally similar to the first preferred embodiment in all other aspects, it is not repeatedly described. In the second preferred embodiment, the drum pedal mechanism 1 further includes a third elastic element 62, which has an end connected to an upper end of the drive arm 41 and another end connected to the cam 42. When the footboard 30 is pedaled downward, the third elastic element 62 is pulled by the drive arm 40 to deform and produce a third elastic restoring force.

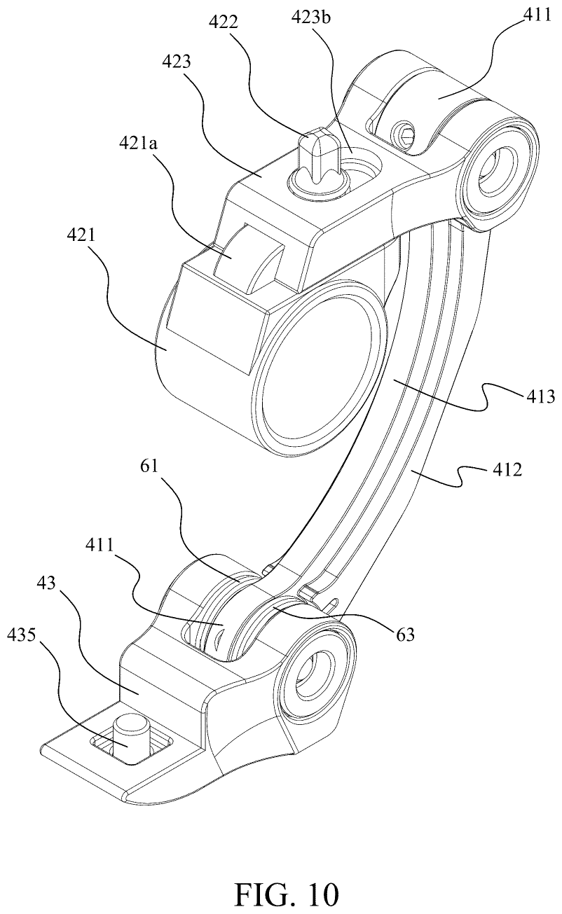

Pleas refer to FIGS. 1, 2, and 10, in which a third preferred embodiment of the present invention is shown. The third preferred embodiment is different from the first one only in the number of the elastic elements. Since the third preferred embodiment is structurally similar to the first preferred embodiment in all other aspects, it is not repeatedly described. In the third preferred embodiment, the drum pedal mechanism 1 further includes a fourth elastic element 63, which has an end connected to the lower end of the drive arm 41 and another end connected to the connection joint 43, such that the second and the fourth elastic element 6, 63 are located at two lateral sides of the drive arm 41 and in the connection space 433. When the footboard 30 is pedaled downward, the fourth elastic element 63 is pulled by the rocker arm assembly 40 to deform and produce a fourth elastic restoring force.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A drum pedal mechanism, comprising:
a footplate assembly including a footplate, two posts, and a rocker shaft; the footplate being provided with a pivotal block at a rear end; the two posts being connected at two laterally opposite sides of the footplate and locates at a front end of the footplate; and the rocker shaft being rotatably connected to a top of the two posts;
a footboard having a pivotal end and a pedaling end; the pivotal end being pivotally connected to the pivotal block of the footplate assembly; and a space is formed between the pedaling end and the footplate, such that the footboard is slant relative to the footplate;
a rocker arm assembly being connected to between the rocker shaft and the pedaling end, and the rocker arm assembly including a drive arm, a cam, and a connection joint; the drive arm being turnably connected to between the cam and the connection joint; the cam being fixedly mounted to the rocker shaft, such that the rocker shaft is capable of being swung synchronously with the cam; and the connection joint being fixedly mounted to the pedaling end, such that the connection joint is capable of being moved synchronously with the footboard;
a first elastic element having an end connected to the rocker shaft and another end connected to one of the two posts; and
a second elastic element having an end connected to the drive arm and another end connected to one of the cam and the connection joint; and
wherein when the footboard is pedaled downward, the first elastic element is deformed by the rocker shaft to produce a first elastic restoring force; meanwhile, the second elastic element is deformed by the drive arm to produce a second elastic restoring force; and then when the footboard is released without pedaling, the footboard is quickly moved upward by the first elastic restoring force and the second elastic restoring force to return to an initial position.

2. The drum pedal mechanism as claimed in claim 1, wherein the footboard is provided with a rearward extended notch at the pedaling end, a part of the connection joint is accommodated in the notch without moving leftward and rightward relative to the pedaling end.

3. The drum pedal mechanism as claimed in claim 1, wherein the connection joint includes a connection body; and the connection body being extended rearward to a lower side of the footboard and being locked to the footboard using a screw.

4. The drum pedal mechanism as claimed in claim 1, wherein the connection joint includes two mounting sections extended forward and a connection space formed between the mounting sections; each of the mounting sections being provided with a through bore communicable with the connection space; the drive arm including a mounting opening, a connection pin, and two bearings; a middle portion of the connection pin being fixedly held in the mounting opening and two opposite end portions of the mounting opening are located outside the mounting opening, the bearings are connected to the end portions of the connection pin respectively; and the bearings being rotatably fitted in the two through bores on the mounting sections, such that the drive arm is capable of being pivotally connected to the connection joint.

5. The drum pedal mechanism as claimed in claim 1, wherein the second elastic element is configured as a coil spring; the drive arm including a locating block for fitting in a central area of the coil spring and a first locating hole located adjacent to the locating block; one of the cam and the connection joint being provided with a second locating hole, and the coil spring having two opposite ends separately fixedly fitted in the first locating hole and the second locating hole.

6. The drum pedal mechanism as claimed in claim 5, wherein a first gap is formed between the coil spring and the locating block when the footboard is not pedaled; and the coil spring being deformed by the drive arm to form a second gap when the footboard is pedaled downward, the second gap is smaller than the first gap.

7. The drum pedal mechanism as claimed in claim 5, wherein the drive arm includes two pivot portions, an arm portion, and a rib portion; the arm portion being connected between the two pivot portions, and the rib portion being connected to between the pivot portions and the arm portion; the locating block fitted in the coil spring being provided on one of the pivot portions, a receiving space being formed between the locating block and the arm portion, and a recessed portion being provided on the arm portion for forming the first locating hole; and the locating block having a top being flush with the arm portion, such that the coil spring is mounted in the receiving space and the recessed portion.

8. The drum pedal mechanism as claimed in claim 1, further comprising a third elastic element, the third elastic element has an end connected to the drive arm and another end connected to another of the cam and the connection joint; and the third elastic element being deformed by the rocker arm assembly to produce a third elastic restoring force when the footboard is pedaled downward.

9. The drum pedal mechanism as claimed in claim 1, wherein the cam includes a fixing section, a fastening element, and a sliding section; the fixing section being fixedly mounted on the rocker shaft, such that the rocker shaft is capable of being swung synchronously with the cam; one end of the sliding section being pivotally connected to the drive arm, and the other end of the sliding section being slidably connected to the fixing section; so that a relative position between the sliding section and the fixing section is capable of being adjusted to change an overall length of the cam, and the sliding section is capable of being fixed by the fastening element without moving relative to the fixing section.
